(19) United States
(12) Patent Application Publication
(10) Pub. No.: US 2005/0160178 A1
(43) Pub. Date: Jul. 21, 2005

(54) Adjusting shaped rates

(76) Inventor: Bradley D. Venables, Nepean (CA)

Correspondence Address: FISH & RICHARDSON PC, 225 FRANKLIN ST, BOSTON, MA, 02110, US

(21) Appl. No.: 10/739,448

(22) Filed: Dec. 17, 2003

(51) Int. Cl. G06F 15/16

(52) U.S. Cl. 709/233

(57) ABSTRACT

Systems, including computer program products, and methods for modifying an effective data rate are described. The systems and methods include receiving data at a traffic rate scheduler and determining an amount of interference traffic to send to the traffic rate scheduler. The method also includes inserting interference traffic with the data in the traffic rate scheduler.

### BACKGROUND

A computer system can include a centralized server or service card that provides data to a plurality of other computers or cards. In such a centralized architecture, the server or service card is required to provide data to multiple other computers or cards at data rates that meet predefined criteria. Criteria include contracted rates, physical data channel rates, and quality of service objectives. In some applications, the component of the centralized server responsible for shaping the data to the required rate is incapable of meeting the criteria without an assisting circuit for adjusting the rate of the shaping component. The assisting circuit for adjusting the rate of the server or centralized card is responsible for correlating the behavior of the server card with the requirements of the systems that are receiving the information and using this knowledge to adjust the rate shaping behavior of the server or centralized card.

### SUMMARY

In one aspect, there are systems and methods that include receiving data at a traffic rate scheduler and determining an amount of interference traffic to send to the traffic rate scheduler. The systems and methods also include inserting interference traffic with the data in the traffic rate scheduler.

Other embodiments can also include one or more of the following. Inserting interference traffic can modify a data output rate of the traffic rate scheduler. Inserting interference traffic with the data for delivery to the queue in the traffic rate scheduler can include inserting the interference data in a queue. The queue can be a priority queue. An amount of interference traffic can be an ongoing rate of interference traffic or a quantity of interference traffic.

The systems and methods can include receiving information about the state of a system receiving the data, an output data rate of the traffic rate scheduler, and a data rate of data entering the traffic rate scheduler. Determining an amount of interference traffic sent to the traffic rate scheduler can include determining an amount of interference traffic sent to the traffic rate scheduler based on the information. The state of a system receiving the data can refer to the amount of data in the queue of another scheduling system or can refer to the amount of data in the queue of a transmission system. The information can include a class of service of the data or a format of the data.

The systems and methods can also include selecting the interference traffic for delivery as if the interference traffic was data. The systems and methods can also include discarding the interference traffic. Discarding the interference traffic can decrease the data output rate of the traffic rate scheduler or decrease an arrival rate of data at a downstream system.

The systems and methods can also include receiving information describing an algorithm employed by the traffic rate scheduler. Determining an amount of interference traffic sent to the traffic rate scheduler can include determining an amount of interference traffic sent to the traffic rate scheduler based on the information. The algorithm employed by the traffic rate scheduler can include cell shaping or asynchronous transfer mode (ATM) shaping.

In another aspect, a system includes a computer program product, tangibly embodied in an information carrier, for executing instructions on a processor, the computer program product being operable to cause a machine to receive data at a traffic rate scheduler, determine an amount of interference traffic to send to the traffic rate scheduler, and insert interference traffic with the data in the traffic rate scheduler.

Other embodiments can also include one or more of the following. The computer program product can include instructions to cause a machine to insert interference traffic to modify a data output rate of the traffic rate scheduler. The computer program product can include instructions to cause a machine to discard the interference traffic.

The computer program product can include instructions to cause a machine to receive information about a state of a system receiving the data, an output data rate of a traffic rate scheduler, a data rate of data entering the traffic rate scheduler, or the data entering the traffic rate scheduler. The instructions to cause the machine to determine an amount of interference traffic sent to the traffic rate scheduler also includes instructions to cause a machine to determine an amount of interference traffic sent to the traffic rate scheduler based on the information.

The use of interference traffic to modify the effective output rate of the traffic rate scheduler on the server or centralized card allows a single traffic rate scheduler to send data at a wide variety of transmission rates. This increases the range of applications and rates that can be supported by a particular traffic rate scheduler.

Insertion and subsequent dropping of interference traffic provides advantages such as effectively modifying the output rate of a traffic rate scheduler without changing the configured output rate of the traffic rate scheduler. The effective output rate of the system can have different behavioral characteristics than the traffic rate scheduler was configured to accommodate alone. System behaviors that the traffic rate scheduler cannot implement alone can be effected by the shaper modification circuit using interference traffic and one or more of the following information sources: traffic scheduler behavior, monitoring of system state, monitoring of traffic scheduled data rate, monitoring of input data, and configured system behavior.

### DESCRIPTION OF DRAWINGS

FIG. 1 is a block diagram depicting a system for processing data frames.

FIG. 2 is a block diagram depicting a traffic rate scheduler, a system, and a shaper modification circuit.

FIG. 3 is a flow chart showing a process to modify a data rate.

FIG. 4 is a flow chart depicting a process to determine an interference traffic rate.

FIG. 5 is a block diagram depicting a traffic rate scheduler, a system and a shaper modification circuit.

FIG. 6 is a block diagram depicting a traffic rate scheduler, a system, and a shaper modification circuit.

### DESCRIPTION

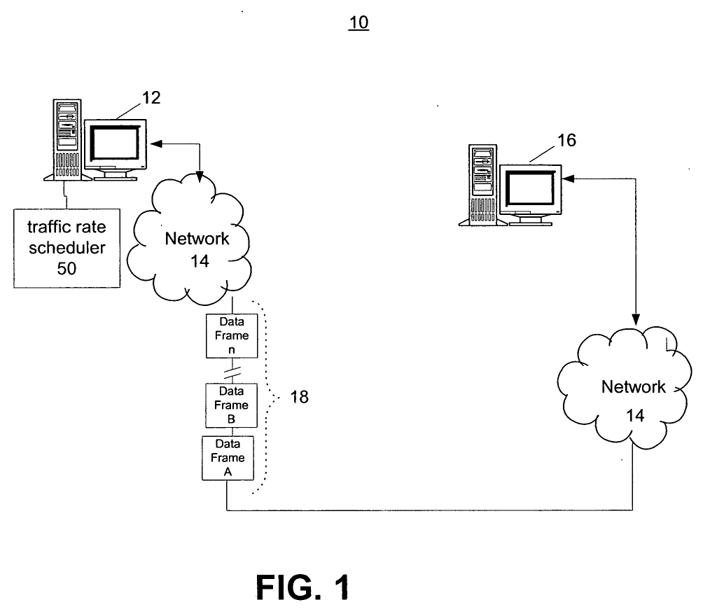

Referring to FIG. 1, a system 10 for transmitting data from a first computer system 12 through a network 14 to another computer system 16 is shown. System 12 delivers stream of “n” data frames 18 to the destination computer system 16. To deliver the appropriate data to the appropriate destination at the appropriate rate, system 12 includes a traffic rate scheduler 50 and a method of measuring and assessing the traffic rate egressing the traffic rate scheduler to meet the known requirements of system 16. System 16 can provide feedback to system 12 directly, or provide the rules for system 12 to monitor the rate. The traffic rate scheduler 50 modifies the data output rate according system behavior upstream or downstream of the traffic rate scheduler. While in this example, the traffic rate scheduler 50 is included in system 12, the traffic rate scheduler could be included in a router and the like.

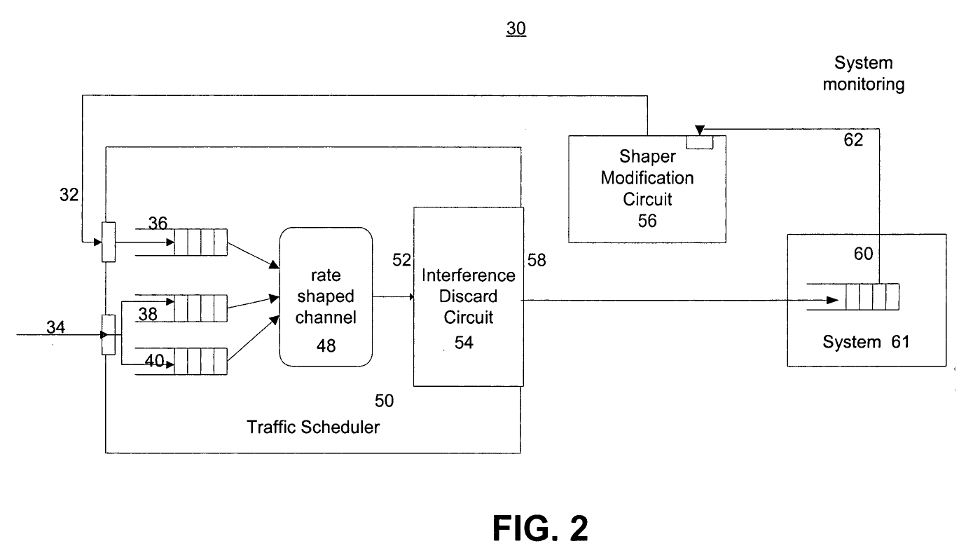

Referring to FIG. 2, the traffic scheduler 50, a shaper modification circuit 56, and a downstream system 61 are shown. The traffic scheduler 50 receives data (as indicated by arrow 34) and sends the data to the downstream system 61, for example to a queue 60. The queue 60 is referred to below as a downstream queue since it is disposed in a data path that is downstream from the traffic rate scheduler 50 and the origin of the data. System 61 monitors the state of queue 60 and sends system monitoring data 62 to a shaper modification circuit 56. The queue 60 has various fill states. For instance, the queue 60 can be full, adequate, or low. When the queue 60 is full, it is desirable to decrease the data rate from the traffic rate scheduler 50 such the queue 60 does not overflow. Alternately, when the downstream queue 60 is low, it can be desirable to increase the data rate from the traffic rate scheduler 50 such that the queue 60 does not starve.

While in this example, the state of a queue 60 is monitored to determine if an output rate from the traffic rate scheduler is adequate, other factors could be monitored. For example, the system can have a predetermined rate and the system 61 monitors the rate of data arriving to the system 61 and sends this data to the shaper modification circuit 56.

In order to modify the effective data output rate of data sent to the downstream queue 60, the traffic scheduler 50 includes a interference traffic queue 36, data queues 38 and 40, and a interference discard circuit 54. The traffic scheduler 50 combines data from the interference traffic queue 36 and data from the data queues 38 and 40 to form a rate shaped channel 48. The traffic scheduler 50 delivers data from the queues 36, 38, and 40 to the rate shaped channel 48 at a constant rate. The interference traffic queue 36 can have a higher priority than queues 38 and 40 so that interference traffic is selected before data if interference traffic is available in the interference traffic queue 36.

The queues 38 and 40 temporarily store incoming data (indicated by arrow 34) for delivery to the downstream system 61. The interference traffic queue 36 is dedicated to storing interference traffic. Interference traffic is traffic inserted into the rate shaped channel 48 to modify the data output rate of the traffic scheduler 50. Interference traffic includes a header or other indication such that a interference discard circuit 54 knows not to deliver the interference traffic to system 61. Interference traffic generally would not include user data for delivery but rather serves as filler in the shaped channel 48 from the perspective of the traffic rate scheduler 50. All data in the rate shaped channel (i.e., data from both the interference traffic queue 36 and the data queues 38 and 40) is passed at a constant rate from the rate shaped channel 48 to interference discard circuit 54 (as indicated by arrow 52). The interference discard circuit 54 determines the origin of the data, discards data originating from the interference traffic queue 36, and sends the remaining data to the downstream system 61 (as indicated by arrow 58). When interference traffic is inserted into the rate shaped channel 48 it effectively lowers the data transmission rate of the traffic scheduler 50 since the interference traffic is not delivered to the downstream system 61.

When data is available in the interference traffic queue 36, the traffic scheduler 50 selects data from the interference traffic queue 36 instead of selecting data from data queues 38 and 40. For example, the interference traffic queue 36 can be a priority queue. A shaper modification circuit 56 determines when to insert interference data into the interference traffic queue 36. The shaper modification circuit 56 receives system monitoring data 62 and based on this data determines a rate at which to insert the interference traffic into the interference traffic queue 36. For example, the system monitoring data 62 can be generated by system 61 monitoring the state of a queue 60 in system 61. In this example, if the downstream queue is full, the shaper modification circuit increases the rate at which it inserts interference data into the interference traffic queue 36. If the queue 60 in system 61 is low or empty, the shaper modification circuit 56 decreases the rate at which it inserts interference traffic into the interference traffic queue 36.

In this example the traffic rate scheduler 50 includes the interference discard circuit 54, the interference discard circuit 54 could be external to the traffic rate scheduler 50. For example, the interference discard circuit 54 could be included on the system receiving the data (e.g., system 61). Alternately, the interference traffic can be discarded anywhere between the rate shaping circuit and the system 61.

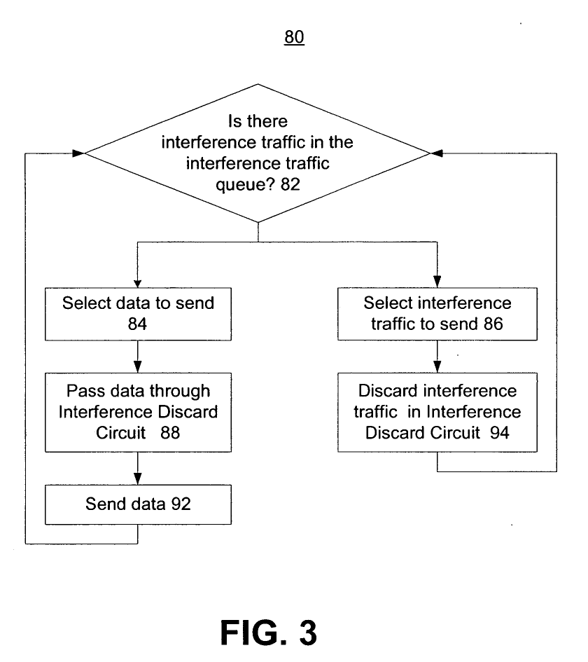

Referring to FIG. 3, a process 80 to modify a data output rate from a traffic scheduler 50 is shown. Process 80 determines 82 if there is interference traffic in a interference traffic queue 36. The interference traffic queue 36 is included in the traffic rate scheduler 50 and stores interference traffic. If there is not interference traffic in the interference traffic queue 36 the traffic scheduler selects 84 data from the data queues 38 and 40 to send to the downstream system 61. Subsequently, process 80 passes 88 the data through the interference discard circuit 54 and sends 92 the data to the downstream system. If process 80 determines 82 that there is interference traffic in the interference traffic queue, process 80 inserts 86 the data from the interference traffic queue into the rate shaped channel 48. Process 80 discards 94 the interference traffic and returns to the initial state of determining 82 if there is interference traffic in the interference traffic queue.

While in this example, the traffic rate scheduler selects the interference traffic for delivery before selecting the other data, however, the traffic rate scheduler could have a different priority for the interference traffic. For example, data from a particular source can be selected before the interference traffic. In another example, the traffic rate scheduler includes a single queue and the interference traffic is inserted and delivered based on the arrival time (e.g., a first in first out (FIFO) arrangement).

For example, if a downstream system is capable of receiving data at a rate of 800 Kbits/sec and the traffic rate scheduler 50 delivers data in the rate shaped channel 48 at a rate of 1 Mbit/sec, the shaper modification circuit 56 inserts interference data into the interference traffic queue at a rate of 200 Kbits/sec. Thus, one in every five bytes of data would include interference data. The traffic rate scheduler 50 delivers the interference data along with the real data at the rate of 1 Mbit/sec. However, the interference discard circuit 54 drops 1 in every 5 bytes (i.e. one byte of interference traffic is dropped for every 4 bytes of real data transmitted) to compensate for the rate difference between the two queues. Thus, the effective delivery rate to the destination queue 60 is 800 Kbits/sec.

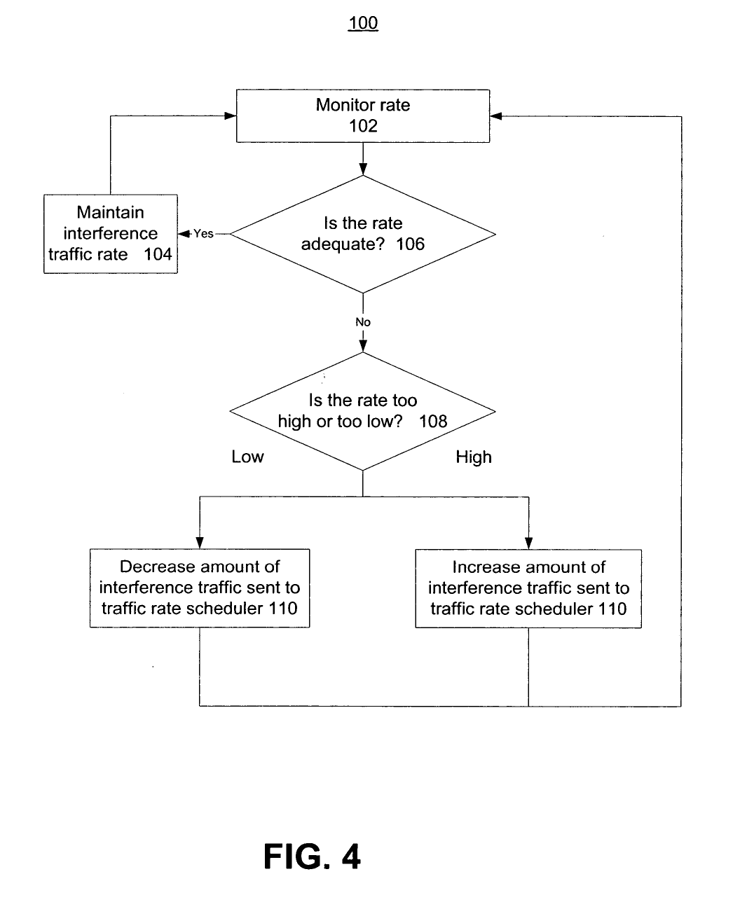

Referring to FIG. 4, a process 100 for determining a rate to send interference traffic to the interference traffic queue is shown. Process 100 includes monitoring 102 a rate. Process 100 determines 106 if the rate is adequate (i.e., if the output rate from the traffic scheduler 50 is appropriate). If the output rate is adequate, process 100 maintains 104 the current delivery rate of interference to the interference traffic queue 36. This maintains the same effective data output rate from the traffic scheduler 50, since the frequency of dropped interference traffic is unchanged. If process 100 determines 106 that the rate is not adequate, process 100 determines 108 if the rate is too high or too low. If process 100 determines that the rate is too low, the data output rate from the traffic scheduler 50 to the downstream queue 60 should be increased. To increase the data output rate, process 100 decreases 110 the delivery rate of interference traffic sent to the interference traffic queue 36. Thus, since less interference data is included in the rate shaped channel 48 and the interference discard circuit 54 discards less data, and the effective data rate to the downstream queue 60 increases.

If process 100 determines the rate is too high, the data output rate from the traffic scheduler 50 to the downstream queue 60 should be decreased. To decrease the data output rate, process 100 increases 112 the rate for sending interference traffic to the interference traffic queue 36. Thus, since more interference data is included in the rate shaped channel 48 and the interference discard circuit 54 discards more data, and the effective data rate to the downstream queue 60 decreases. Subsequent to increasing 110 or decreasing 112 the rate of sending interference traffic to the interference traffic queue 36, process 100 returns to the initial state of monitoring 102.

In the example above, system 61 accommodates a transmission rate of 800 Kbits/second. However, this rate can vary over time. For example, the rate can increase to 900 Kbits/second. In this case, the queue would empty (e.g., the rate is too low) and the shaper modification circuit is alerted of the state of the queue. Based on the queue level being too low, the shaper modification circuit decreases the amount and rate of data sent to the interference traffic queue 36. For example, the rate could be decreased to 100 Kbits/sec resulting in an effective transmission rate to queue 60 of 900 Kbits/sec. Based on the state of the queue 60 using this transmission rate, the interference traffic rate could be further adjusted or kept at the 900 Kbits/sec.

While in the examples above the shaper modification circuit receives information about the state of a downstream system 61, the shaper modification circuit can receive other information. The shaper modification circuit can receive information from a variety of monitoring systems, for example, the monitoring can include queue state monitoring, output rate monitoring, or monitoring input data characteristics. Alternately, the shaper modification circuit includes a steady state algorithmic modification to the behavior of the traffic rate scheduler.

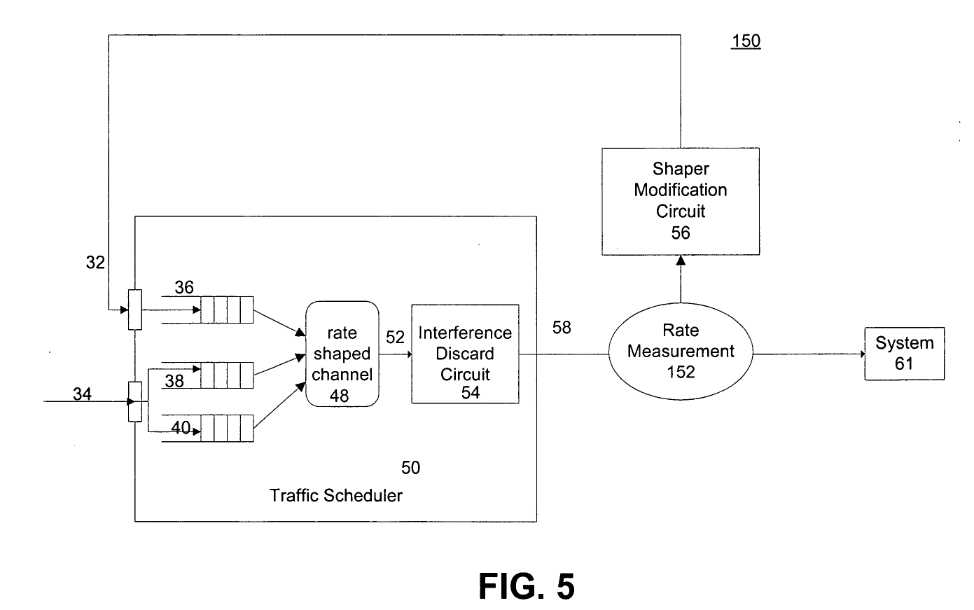

Referring to FIG. 5, a system 150 including a traffic rate scheduler 50, shaper modification circuit 56, and downstream system 61 is shown. As described above, the traffic rate scheduler receives interference traffic from the shaper modification circuit 56. The interference traffic is stored in a interference traffic queue 36 and inserted into a rate shaped channel 48. The rate shaped channel 48 delivers data at a constant rate. In order to modify an output rate, an interference discard circuit 54 discards the interference traffic. The interference discard circuit 54 can be in the traffic rate scheduler 50 or external to the traffic rate scheduler 50, but prior to the rate measurement device 152. In this example, the shaper modification circuit modifies the rate at which it sends interference traffic to the traffic scheduler based on information from a rate measurement device 152. The rate measurement device monitors a stream of data 58 sent from the interference discard circuit 54 to the downstream system 61. The measurement device provides data such as the delivery rate to the shaper modification circuit 56. The shaper modification circuit 56 includes information about the desired data rate of the downstream system. This information can be obtained by a rate measurement device or can be programmed into the shaper modification circuit by a user. Thus, based on a comparison of the data rate desired by the downstream system and the actual data rate measured by rate measurement device 152, the shaper modification circuit adjusts the amount of interference traffic send to the traffic scheduler.

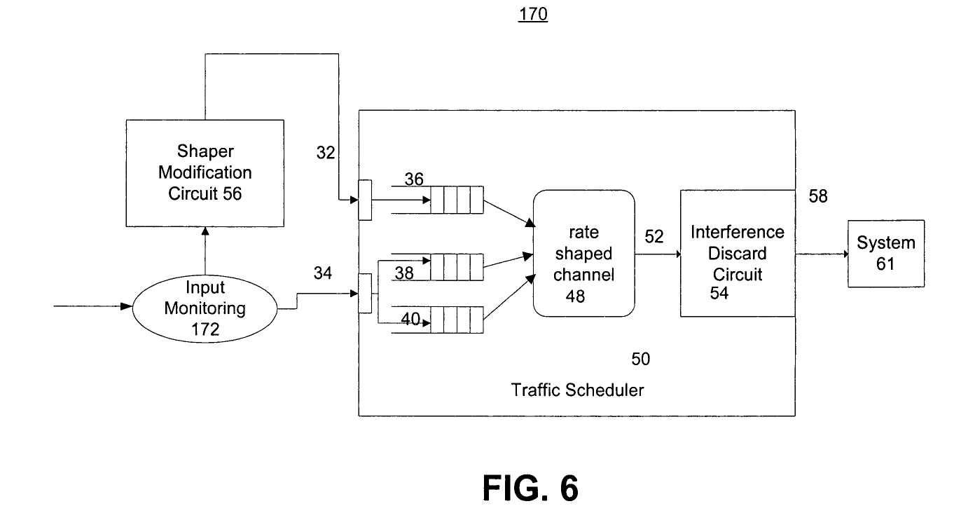

Referring to FIG. 6, a system 170 including a traffic rate scheduler 50, a shaper modification circuit 56, and a downstream system 61 is shown. The traffic rate scheduler adjusts the delivery rate of traffic to the downstream system as discussed above. In this example, the shaper modification circuit determines the amount of interference data to send to the traffic rate scheduler 50 based on a rate measurement of data entering the traffic rate scheduler 50. An input monitoring system 172 measures the data rate of a stream of data 34 entering the traffic rate scheduler 50. The input monitoring system 172 can include information about the behavior of the traffic rate scheduler or can simply observe the system state. Based on the arrival rate of data, downstream system capabilities, and performance of the traffic rate scheduler the shaper modification circuit 56 inserts an appropriate amount of interference traffic into interference traffic queue 36.

In another example, the downstream system receives data from multiple sources. In this example, the stream of data entering the downstream system or the system itself is monitored. Based on the monitored characteristics, the shaper modification circuit 56 inserts an appropriate amount of interference traffic in the traffic rate scheduler 50 to adjust the output rate from the traffic rate scheduler 50.

In several of these examples, the shaper modification circuit 50 controls the shaped flow when the downstream system is not capable of receiving data at the current shaped rate. Although physical flow control capabilities are usually provided in traffic rate schedulers for a small number of channels, the interference traffic technique adds scalability in terms of number of flow controllable channels, and moves the flow control to a different level of the scheduling hierarchy from the channel scheduler to the rate shaper circuit.

The devices described herein can be implemented in digital electronic circuitry, in computer hardware, firmware, software, or in combinations of them. The devices described herein can be implemented as a computer program product, i.e., a computer program tangibly embodied in an information carrier, e.g., in a machine-readable storage device or in a propagated signal, for execution by, or to control the operation of, data processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Particular embodiments have been described, however other embodiments are within the scope of the following claims.

1. A method comprising:
receiving data,
receiving interference traffic, and
inserting interference traffic with the data for delivery from traffic rate scheduler.

2. The method of claim 1 wherein inserting interference traffic modifies a data output rate of the traffic rate scheduler.

3. The method of claim 1 further comprising storing the interference traffic in a queue.

4. The method of claim 3 wherein the queue is a priority queue.

5. The method of claim 1 further comprising selecting the interference traffic for delivery.

6. The method of claim 5 further comprising discarding the interference traffic.

7. The method of claim 6 wherein discarding the interference traffic decreases a data output rate of the traffic rate scheduler.

8. The method of claim 6 wherein discarding the interference traffic decreases an arrival rate of data at a downstream system.

9. A method comprising:
receiving information about a data rate,
determining an amount of interference traffic to send to a traffic rate scheduler based on the information, and
sending interference traffic to a traffic rate scheduler.

10. The method of claim 9 wherein the information includes the state of the system receiving data from the traffic rate scheduler.

11. The method of claim 9 wherein the information includes an amount of data in a queue of a transmission system.

12. The method of claim 9 wherein the information includes information about an output data rate of the traffic rate scheduler.

13. The method of claim 9 wherein the information includes information describing data entering the traffic rate scheduler.

14. The method of claim 9 wherein the information includes information describing an algorithm employed by the traffic rate scheduler.

15. The method of claim 1 wherein the amount of interference traffic is an ongoing rate of interference traffic or a quantity of interference traffic.

16. A computer program product, tangibly embodied in an computer readable medium, for executing instructions on a processor, the computer program product being operable to cause a machine to:
receive data,
receive interference traffic,
insert interference traffic with the data for delivery from traffic rate scheduler.

17. The computer program product of claim 16 further comprising instructions to cause a machine modify a data output rate of the traffic rate scheduler.

18. The computer program product of claim 16 further comprising instructions to cause a machine to store the interference traffic in a queue.

19. The computer program product of claim 16 further comprising instructions to cause a machine select the interference traffic for delivery.

20. The computer program product of claim 16 further comprising instructions to cause a machine to discard the interference traffic.

21. A computer program product, tangibly embodied in an computer readable medium, for executing instructions on a processor, the computer program product being operable to cause a machine to:
receive information about a data rate,
determine an amount of interference traffic to send to a traffic rate scheduler based on the information, and
send interference traffic to a traffic rate scheduler.

22. The computer program product of claim 21 wherein the information includes the state of the system receiving data from the traffic rate scheduler.

23. The computer program product of claim 21 wherein the information includes an amount of data in a queue of a transmission system.

24. The computer program product of claim 21 wherein the information includes information about an output data rate of the traffic rate scheduler.

25. The computer program product of claim 21 wherein the information includes information describing data entering the traffic rate scheduler.

26. A device configured to:
receive data,
receive interference traffic,
insert interference traffic with the data in the traffic rate scheduler.

27. The device of claim 26 further configured to modify a data output rate of the traffic rate scheduler.

28. The device of claim 26 further configured to select the interference traffic for delivery.

29. The device of claim 26 further configured to discard the interference traffic.

30. A device configured to:
receive information about a data rate,
determine an amount of interference traffic to send to a traffic rate scheduler based on the information, and
send interference traffic to a traffic rate scheduler.

31. The device of claim 30 wherein the information includes information about an output data rate of the traffic rate scheduler.

32. The device of claim 30 wherein the information includes information describing data entering the traffic rate scheduler.

33. The device of claim 30 wherein the information includes the state of the system receiving data from the traffic rate scheduler.

34. An system comprising:
a shaper modification circuit; and
a traffic rate scheduler;
the shaper modification circuit configured to determine an amount of interference traffic to send to the traffic rate scheduler,
the traffic rate scheduler configured to receive data, and
insert interference traffic with the data in the traffic rate scheduler.

35. The system of claim 34 wherein the shaper modification circuit is configured to insert interference traffic to modify a data output rate of the traffic rate scheduler.

36. The system of claim 34 wherein the shaper modification circuit is configured to receive information about a state of a system receiving the data.

37. The system of claim 34 further comprising a rate measurement device configured to generate information about a data rate.

38. The system of claim 34 further comprising a rate measurement device configured to generate information about data entering the traffic rate scheduler.

39. The system of claim 34 wherein the shaper modification circuit is configured to discard the interference traffic.
